(19) United States
(12) Patent Application Publication
(10) Pub. No.: US 2023/0286189 A1
(43) Pub. Date: Sep. 14, 2023

(54) Flexible Form Device

(71) Applicant: Paul Wallace Murphy, Hastings, MN (US)

(72) Inventor: Paul Wallace Murphy, Hastings, MN (US)

(21) Appl. No.: 18/057,367

(22) Filed: Nov. 21, 2022

Related U.S. Application Data
(60) Provisional application No. 63/318,308, filed on Mar. 9, 2022.

(51) Int. Cl. B28B 7/06; B28B 7/00

(52) U.S. Cl. CPC B28B 7/06; B28B 7/0014; B28B 2007/005

(57) ABSTRACT

A flexible form device is intended to provide users with a product that allows curved shapes to be poured with concrete while still providing the structural stability needed to hold back large amounts of poured concrete. To accomplish this, the device includes a flexible form device that may be arranged in different shapes and forms. Further, the device includes a plurality of attachment means for securely attaching the flexible forms to the surface on which the concrete may be poured. Furthermore, the device includes connecting segments that help retain specific shape and fixed spacing between multiple flexible panels. Additionally, one flexible form device maybe used multiple times to make multiple structures, without losing the integrity of the device. Thus, the device provides an environment friendly and cost-effective apparatus for creating curved structures and shapes with concrete or other liquid to solid transforming materials.

### FIELD OF THE INVENTION

The present invention relates generally to apparatuses for pouring and forming concrete. Specifically, the present invention relates to a flexible form for setting concrete.

### BACKGROUND OF THE INVENTION

Concrete is a building material that can be poured as a fluid and formed into any shape, hardening over time to assume that shape. Concrete forms are used to create a boundary before pouring concrete to ensure that the final product takes the desired shape. To secure a concrete form in place, stakes are often attached to the concrete form and driven into the ground. Due to the weight of concrete, rigid metal and wood beams are generally used for the concrete forms to ensure that the poured concrete is contained within the desired area.

While rigid wood and metal concrete forms are suitable for pouring concrete along a straight line, some projects require concrete to be poured in a less linear manner, with curves in the shape. For example, a curving walkway could not be easily achieved through the use of a rigid mold. Some commercial curved concrete structures such as sidewalks and driveways may have mold specifically created for them, but most custom projects do not have readymade molds.

An objective of the present invention is to provide users with a product that allows curved shapes to be poured with concrete while still providing the structural stability needed to hold back large amounts of poured concrete. To accomplish this, the present invention comprises a flexible form device that may be arranged in different shapes. Further, the present invention maybe used multiple times without losing the integrity of the device, thereby providing an environment friendly and cost-effective product that can create curved structures and shapes with concrete or other liquid to solid transforming materials.

### SUMMARY OF THE INVENTION

An objective of the present invention is to provide users with a product that allows curved shapes to be made with concrete while still providing the structural stability needed to hold back large amounts of poured concrete. To accomplish this, the present invention comprises a flexible form device that may be arranged in different shapes and forms. Further, the present invention comprises a plurality of securing means for securely attaching the flexible forms to the surface on which the concrete may be poured. Furthermore, the present invention comprises connecting devices that help retain specific shape and fixed spacing between multiple flexible panels. Additionally, the present invention maybe used multiple times without losing the integrity of the device, thereby providing an environment friendly and cost-effective form device for creating curved structures and shapes with concrete or other liquid to solid transforming materials.

### BRIEF DESCRIPTION OF THE DRAWINGS

FIG. 1 is a top front left perspective view of a flexible form and a plurality of securing pipes of the present invention in accordance with at least one embodiment.

FIG. 2 is a top rear right perspective view of the present invention.

FIG. 3 is a perspective view of one of the plurality of stakes of the present invention in accordance with at least one embodiment.

FIG. 4 is a top front left perspective view of the plurality of stakes connected to the form and plurality of securing pipes of the present invention.

FIG. 5 is a perspective view of a connector of the present invention in accordance with at least one embodiment.

FIG. 6 is a perspective view of the connector being mounted between a plurality of flexible form devices.

FIG. 7 is an illustration of the present invention in accordance with at least one embodiment.

FIG. 8 is a perspective view of the present invention wherein the flexible panel is curved to form an almost circular structure form.

### DETAILED DESCRIPTION OF THE INVENTION

All illustrations of the drawings are for the purpose of describing selected versions of the present invention and are not intended to limit the scope of the present invention.

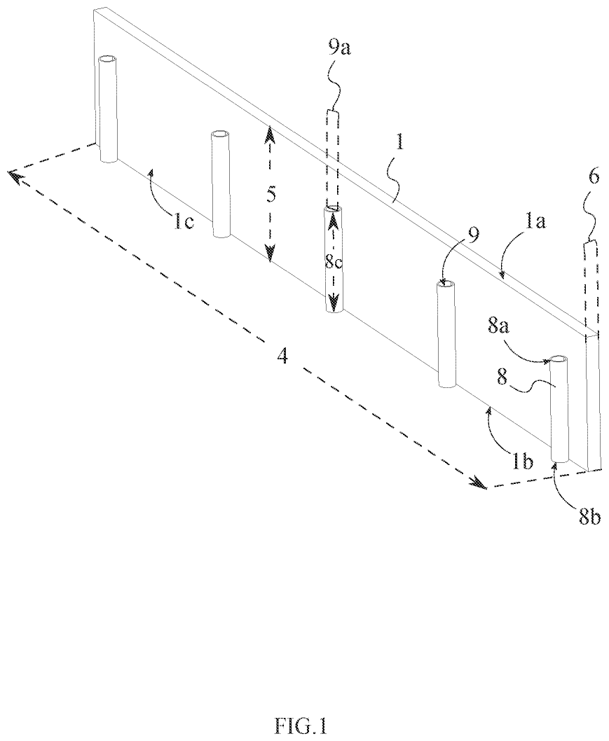

In reference to FIG. 1 through FIG. 8 the present invention is a flexible form device. More specifically, the present invention is a flexible concrete form and associated apparatuses. An objective of the present invention is to provide users with a product that allows curved shapes to be formed with concrete while still providing the structural stability needed to hold back large amounts of poured concrete. To accomplish this, the present invention comprises a flexible form device that may be arranged in different shapes and forms. Further, the present invention comprises a plurality of securing means for securely attaching the flexible forms to the surface on which the concrete may be poured. Furthermore, the present invention comprises connecting devices that help retain specific shape and fixed spacing between multiple flexible panels. Additionally, the present invention maybe used multiple times without losing the integrity of the device, thereby providing an environment friendly and cost-effective form device for creating curved structures and shapes with concrete or other liquid to solid transforming materials.

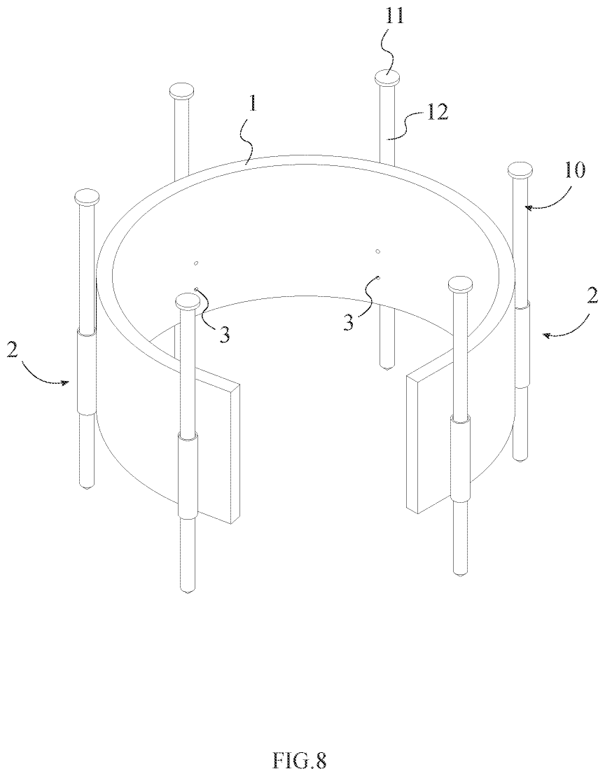

The following description is in reference to FIG. 1 through FIG. 8. According to a preferred embodiment, the present invention comprises at least one flexible panel 1, a plurality of securing devices 2, and a plurality of first fasteners 3. Preferably, the at least one flexible panel 1 is a beam that can be placed against the against the ground to stop the flow of concrete past the point where it is placed. In the preferred embodiment, the at least one flexible panel 1 is a rectangular prism and is flexible along a length 4 of the flexible panel 1. In other words, the form is flexible, allowing for the interior and exterior faces of the panel to become curved. For example, in some uses, the flexible panel 1 may be curved to the point that terminal ends of the flexible panel 1 may be near one another or in contact with one another, as shown in FIG. 8. Preferably, the flexible panel 1 is made of high-density plastic or vinyl, which allows it to be used multiple times without losing the integrity of the panel. However, the at least one flexible panel 1 may comprise any other size, shape, material, components, arrangement of components etc. that are known to one of ordinary skill in the art, as long as the intents of the present invention are not altered.

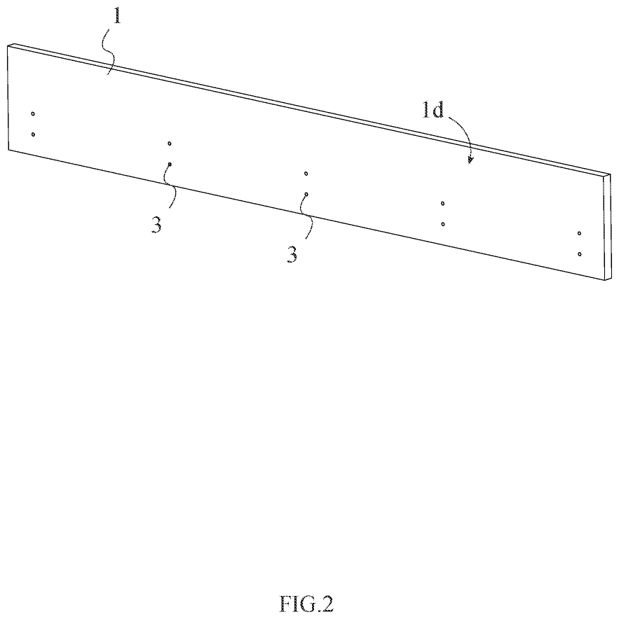

In the preferred embodiment, the at least one flexible panel 1 comprises a first end 1a, a second end 1b, a first surface 1c and a second surface 1d. As seen in FIG. 1 and FIG. 2, the first end 1a is positioned opposite to the second end 1b across a width 5 of the at least one flexible panel 1, and the first surface 1c is positioned opposite to the second surface 1d across a thickness 6 of the flexible panel 1. More specifically, the first end 1a constitutes a top end of the flexible panel 1 and the second end 1b constitutes a bottom end that would be attached to a ground surface. Further, in the preferred embodiment, the flexible panel 1 is rectangular in shape and hence the first surface 1c and the second surface 1d are the bendable opposite surfaces of the flexible panel 1 or form. In other words, the form or panel is flexible, allowing for the interior and exterior faces to become curved. For example, in some uses, the flexible panel 1 may be curved to the point that the first end 1a and second end 1b of the flexible panel 1 may be near one another or in contact with one another, as shown in FIG. 8.

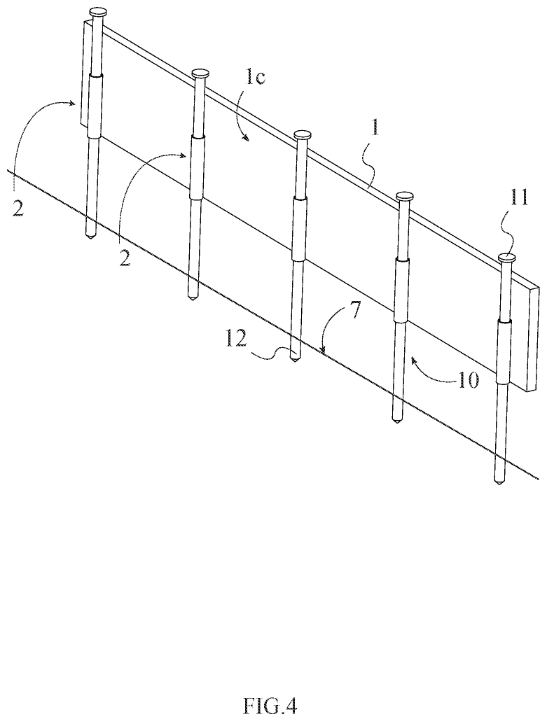

Continuing with the preferred embodiment, and as seen in FIG. 1 and FIG. 4 the plurality of securing devices 2 is laterally mounted onto the flexible panel 1. Preferably, the plurality of securing devices 2 of the present invention is a group of mechanisms configured to allow the flexible panel 1 to be easily attached to the ground or another object. In other words, the plurality of securing devices 2 is operably coupled between the at least one panel 1 and a mounting surface 7, wherein fastening the plurality of securing devices 2 securely attaches the second end 1b of the at least one flexible panel 1 to the mounting surface 7. As seen in FIG. 4, the plurality of securing devices 2 is evenly distributed along the length 4 of the flexible panel 1. In the preferred embodiment, the plurality of securing devices 2 comprises hollow pipes with stakes that can go through the pipes. However, the plurality of securing devices 2 may comprise any other technology, size, shape, components, arrangement of components etc. that are known to one of ordinary skill in the art, as long as the intents of the present invention are not altered.

In order to attach the plurality of securing devices 2 onto the flexible panel 1, the plurality of first fasteners 3 is integrated between the plurality of securing devices 2 and the at least one panel 1. In the preferred embodiment, and as seen in FIG. 2, the plurality of first fasteners 3 comprises rivets that may be threaded through holes in the flexible panel 1. In other words, the attaching means for the securing devices is a plurality of holes allowing the plurality of securing pipes to be attached to the flexible panel 1 by bolts or rivets. However, in alternative embodiments, the plurality of first fasteners 3 may comprise any other variety of attachment means, such as a frame that accepts the plurality of securing pipes, an adhesive, magnetic fastener, hook and loop fastener etc.

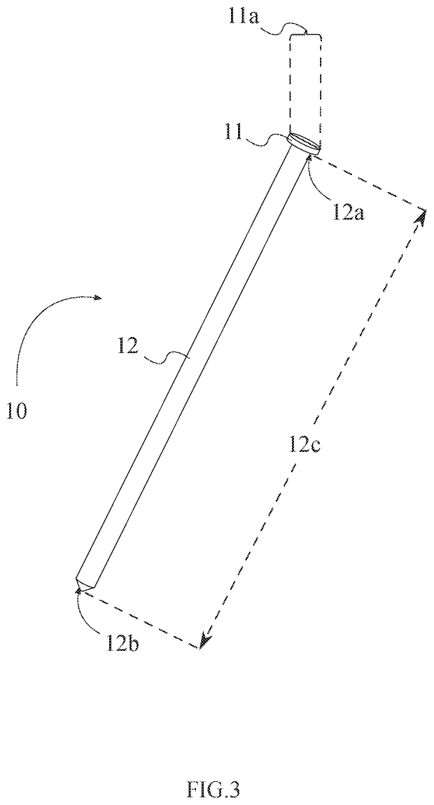

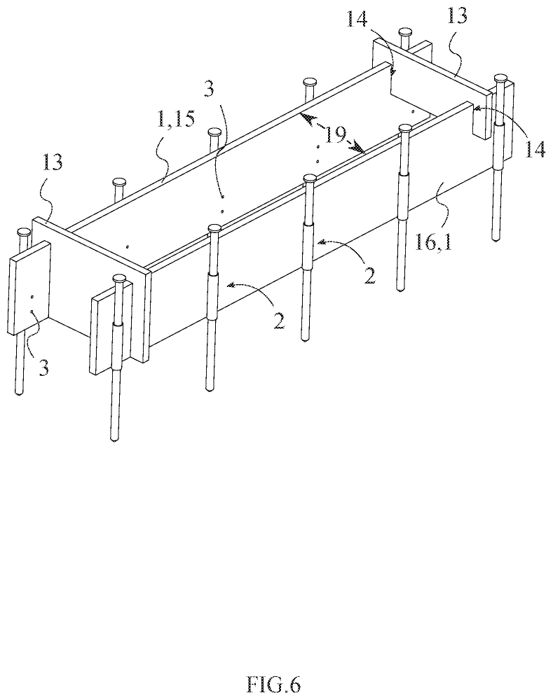

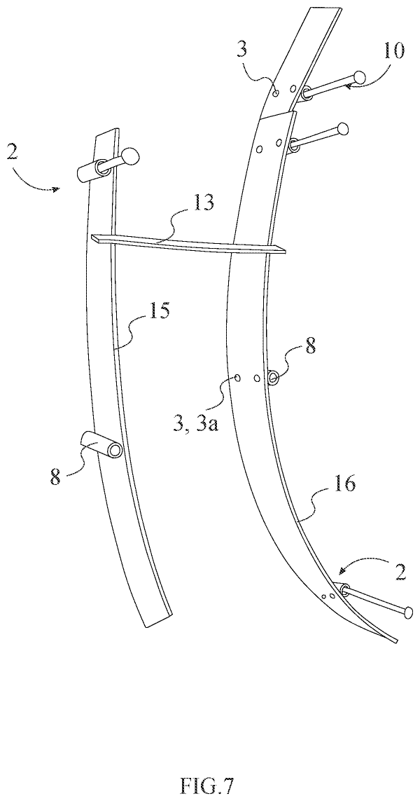

As seen in FIG. 1, FIG. 3, FIG. 4, and FIG. 6 through FIG. 8, each of the plurality of securing devices 2 comprises a cylindrical pipe 8, a cavity 9, and a stake 10. In the preferred embodiment, the cylindrical pipe 8 is a hollow tube having a third end 8a and a fourth end 8b. To that end, the cavity 9 traverses through the cylindrical pipe 8. Further, the third end 8a constitutes a top end of the cylindrical pipe 8 and the fourth end 8b constitutes a bottom end of the cylindrical pipe 8. In the preferred embodiment, the third end 8a is positioned opposite to the fourth end 8b across the cylindrical pipe 8. Furthermore, the third end 8a is oriented towards the first end 1a of the flexible panel 1, and the fourth end 8b of the cylindrical pipe 8 is positioned adjacent to the second end 1b of the flexible panel 1. In other words, when attached, the top end of each of the plurality of securing pipes is oriented toward the top face of the form and the bottom end of each of the plurality of securing pipes is oriented toward the bottom face of the form. This is so that it is easier for users to secure the flexible panel 1 to the ground with the help of the securing devices 2. To that end, the plurality of securing devices 2 is mounted adjacent to the second end 1b of the flexible panel 1. As seen in FIG. 1, and FIG. 7, the cylindrical pipe is 8 mounted onto the first surface 1c of the flexible panel 1, such that the opposite second surface 1d along which the concrete mixture is poured, remains clean and even without any obstructions.

As shown in FIG. 7, the plurality of securing devices 2 is attached to the form or flexible panel 1 by connecting the exterior face (first surface 1c) to the attaching means or first fasteners 3. In other words, a corresponding first fastener 3a is integrated between the cylindrical pipe 8 and the flexible panel 1, wherein the corresponding first fastener 3a is from the plurality of first fasteners 3.

In reference to FIG. 3, the stake 10 comprises a stake head 11 and a stake body 12. In the preferred embodiment, the stake 10 is a pole or rod having a cylindrical body and a head attached to one end of the stake body 12. In other words, the stake head 11 is mounted onto a first terminal end 12a of the stake body 12. In the preferred embodiment, the cavity 9 traverses through the cylindrical pipe 8 such that the stake body 12 maybe threaded through the cavity 9 and the stake 10 can attach to the mounting surface 7 to form a strong hold. As seen in FIG. 4, the stake head 11 is positioned outside the cavity 9, opposite to the mounting surface 7. Further, a second terminal end 12b of the stake body 12 is oriented towards the mounting surface 7, wherein the second terminal end 12b is positioned opposite to the first terminal end 12a across the stake body 12. Furthermore, the second terminal end 12b of the stake body 12 is made pointed, so as to enable easier traversal of the stake body 12 into the mounting surface 7.

In order to function smoothly and secure a strong bond between the mounting surface 7 and the flexible panel 1, a first length 12c of the stake body 12 is made longer than a second length 8c of the cylindrical pipe 8, and a first diameter 11a of the stake head 11 is longer than a second diameter 9a of the cavity 9. In other words, the point of the stake 10 and the body of the stake 10 are sized to be able to fit through the cylindrical pipe 8. More specifically, the stake head 11 is generally larger than the stake body 12, such that the stake head 11 is unable to pass through the cavity 9 of the cylindrical pipe 8 or securing pipe. In securing the flexible panel 1 to the ground, as shown in FIG. 4, the point or second terminal end 12b of the stake 10 is passed through the cylindrical pipe 8 and the stake head 11 is pounded to drive the point and body of the stake 10 into the ground (mounting surface 7). By securing each of the plurality of stakes of the plurality of securing devices 2 in the mounting surface 7, the form or flexible panel 1 is secured in place by its connection to the stake 10.

Additionally, the plurality of securing pipes in the preferred embodiment are approximately 80% of the height of the at least one flexible panel 1, though the height may vary among embodiments. In other words, the second length 8c of the cylindrical pipe 8 is smaller than the width 5 of the flexible panel 1, as seen in FIG. 1. This is so that, the dimensions of the each of the plurality of securing devices 2 ensure a better and easier working situation for users while operating the plurality of securing devices 2, and thus helps in securing a stronger hold or bond.

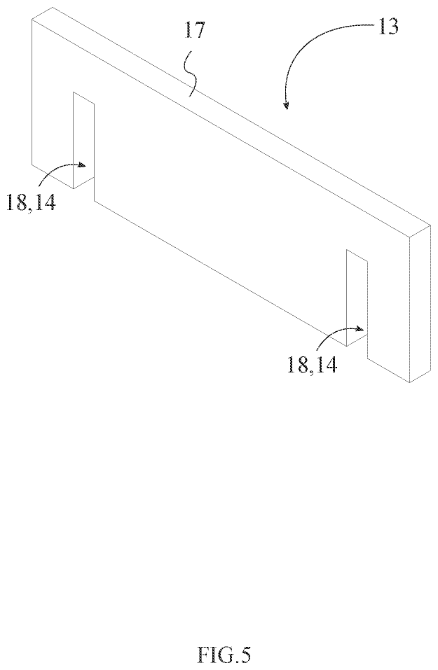

Continuing with the preferred embodiment, the system of the present invention may include multiple forms or flexible panels. In order to connect a plurality of flexible forms or connect two ends of the at least one flexible panel 1, the present invention comprises at least one connector 13 and a plurality of second fasteners 14. More specifically, the at least one connector 13 of the present invention is a piece of material used to connect two of the at least one flexible panel 1 together. For example, and in reference to FIG. 6, the at least one connector 13 is transversely connected between a first panel 15 and a second panel 16, wherein the first panel 15 and the second panel 16 are from the at least one flexible pane 1. Further, the plurality of second fasteners 14 is integrated between the connector 13, the first panel 15, and the second panel 16. In reference to FIG. 5 and FIG. 6, the at least one connector 13 comprises a connector body 17, and a plurality of apertures 18, wherein the plurality of apertures 18 traverses through the connector body 17. In the preferred embodiment, the plurality of apertures 18 acts as the plurality of second fasteners 14, such that the at least one connector 13 may be slid normally along the top end of the at least one flexible panel 1, thereby securing a strong interconnecting connection between two panels. In other words, wherein the plurality of apertures 18 is the plurality of second fasteners 14, the plurality of apertures 18 being configured to slide through the first end 1a of the at least one panel 1. More specifically, the at least one connector 13 is connected to the first end 1a of the at least one flexible panel 1, opposite to the mounting surface 7.

Further, the at least one connector 13 is used to space two of the at least one flexible panel 1 away from each other at a predetermined distance. In other words, and as seen in FIG. 6, the at least one connector 13 delineates a fixed space 19 between the first panel 15 and the second panel 16. The connector may be of any length desired to keep one form a set distance from another form. In its preferred embodiment, the at least one connector 13 of the present invention is rectangular in shape. In other embodiments, the at least one connector 13 may comprise any other shape, size, components, etc. and the plurality of second fasteners 14 may comprise any other connecting mechanism such as a clip or adhesive to attach each of the connector 13 to the at least one flexible panel 1, as long as the intents of the present invention are not altered. Furthermore, the at least one connector 13 may be of the same height as the at least one flexible panel 1 so that it reaches the mounting surface 7 when connected to the at least one flexible panel 1. Alternatively, the at least one connector 13 may be shorter than the flexible panel 1 to allow space between the connector and the ground when the at least one connector 13 is connected to the flexible panel 1. Through these two embodiments, the at least one connector 13 may act similarly to one of the at least one flexible panel 1 to prevent the flow of concrete or may simply connect one of the at least one flexible panel 1 to another to ensure consistent spacing.

Thus, the present invention is a simple, reusable, cost-efficient, and user-friendly form device for creating curved structures and shapes with concrete or other liquid to solid transforming materials.

Although the invention has been explained in relation to its preferred embodiment, it is to be understood that many other possible modifications and variations can be made without departing from the spirit and scope of the invention as hereinafter claimed.

What is claimed is:

1. A flexible form device, comprising:
at least one flexible panel;
a plurality of securing devices;
a plurality of first fasteners;
the at least one flexible panel comprising a first end, a second end, a first surface and a second surface;
the first end being positioned opposite to the second end across a width of the at least one flexible panel;
the first surface being positioned opposite to the second surface across a thickness of the flexible panel;
the plurality of securing devices being laterally mounted onto the first surface of the flexible panel;
the plurality of securing devices being evenly distributed along a length of the flexible panel;
the plurality of first fasteners being integrated between the plurality of securing devices and the at least one panel; and
the plurality of securing devices being operably coupled between the at least one panel and a mounting surface, wherein fastening the plurality of securing devices securely attaches the second end of the at least one flexible panel to the mounting surface.

2. The flexible form device of claim 1, wherein each of the plurality of securing devices comprising:
a cylindrical pipe;
a cavity;
a stake;
the stake comprising a stake head and a stake body;
the cavity traversing through the cylindrical pipe;
the stake head being mounted onto a first terminal end of the stake body;
the cylindrical pipe being mounted onto the first surface of the flexible panel;
a corresponding first fastener being integrated between the cylindrical pipe and the flexible panel, wherein the corresponding first fastener is from the plurality of first fasteners;
the stake body being threaded through the cavity; and
the stake head being positioned outside the cavity, opposite to the mounting surface.

3. The flexible form device of claim 2, comprising:
the cylindrical pipe comprising a third end and a fourth end, wherein the third end being positioned opposite to the fourth end across the cylindrical pipe;
the third end of the cylindrical pipe being oriented towards the first end of the at least one flexible panel; and
the fourth end of the cylindrical pipe being positioned adjacent to the second end of the flexible panel.

4. The flexible form device of claim 2, comprising:
a second terminal end of the stake body being oriented towards the mounting surface, wherein the second terminal end being positioned opposite to the first terminal end across the stake body; and
the second terminal end being pointed.

5. The flexible form device of claim 2, wherein:
a first length of the stake body is longer than a second length of the cylindrical pipe;
a first diameter of the stake head is longer than a second diameter of the cavity; and
the second length of the cylindrical pipe is smaller than the width of the flexible panel.

6. The flexible form device of claim 2, wherein the plurality of securing devices being mounted adjacent to the second end of the flexible panel.

7. The flexible form device of claim 1, wherein the plurality of first fasteners are rivets.

8. The flexible form device of claim 1, comprising:
at least one connector;
a plurality of second fasteners;
the at least one connector being transversely connected between a first panel and a second panel, wherein the first panel and the second panel are from the at least one flexible panel; and
the plurality of second fasteners being integrated between the connector and the at least one panel.

9. The flexible form device of claim 8, wherein the at least one connector comprising:
a connector body;
a plurality of apertures;
the plurality of apertures traversing through the connector body; and
wherein the plurality of apertures is the plurality of second fasteners, the plurality of apertures being configured to slide through the first end of the at least one panel.

10. The flexible form device of claim 8, wherein the at least one connector delineating a fixed space between the first panel and the second panel.

11. The flexible form device of claim 8, wherein the at least one connector being connected to the first end of the at least one flexible panel, opposite to the mounting surface.

12. The flexible form device of claim 1, wherein the at least one flexible panel being flexible along the length of the panel.

13. A flexible form device, comprising:
at least one flexible panel;
a plurality of securing devices;
a plurality of first fasteners;
the at least one flexible panel comprising a first end, a second end, a first surface and a second surface;
each of the plurality of securing devices comprising a cylindrical pipe, a cavity, and a stake;
the stake comprising a stake head and a stake body;
the first end being positioned opposite to the second end across a width of the at least one flexible panel;
the first surface being positioned opposite to the second surface across a thickness of the flexible panel;
the plurality of securing devices being evenly distributed along a length of the flexible panel;
the cavity traversing through the cylindrical pipe;
the stake head being attached to a first terminal end of the stake body;
the cylindrical pipe being laterally mounted onto the first surface of the flexible panel;
the plurality of first fasteners being integrated between the plurality of securing devices and the at least one panel;
a corresponding first fastener being integrated between the cylindrical pipe and the flexible panel, wherein the corresponding first fastener is from the plurality of first fasteners; and
each of the plurality of securing devices being operably coupled between the at least one panel and a mounting surface, wherein threading the stake body through the cavity and fastening the stake body to the mounting surface, securely attaches the second end of the at least one flexible panel onto the mounting surface.

14. The flexible form device of claim 13, wherein the stake head being positioned outside the cavity, opposite to the mounting surface.

15. The flexible form device of claim 13, comprising:
a second terminal end of the stake body being oriented towards the mounting surface, wherein the second terminal end being positioned opposite to the first terminal end across the stake body; and
the second terminal end being pointed.

16. The flexible form device of claim 13, wherein:
a first length of the stake body is longer than a second length of the cylindrical pipe;
a first diameter of the stake head is longer than a second diameter of the cavity; and
the second length of the cylindrical pipe is smaller than the width of the flexible panel.

17. The flexible form device of claim 13, comprising:
at least one connector;
a plurality of second fasteners;
the at least one connector being transversely connected between a first panel and a second panel, wherein the first panel and the second panel are from the at least one flexible panel; and
the plurality of second fasteners being integrated between the connector and the at least one panel.

18. The flexible form device of claim 17, wherein the at least one connector comprising:
a connector body;
a plurality of apertures;
the plurality of apertures traversing through the connector body; and
wherein the plurality of apertures is the plurality of second fasteners, the plurality of apertures being configured to slide through the first end of the at least one panel.

19. The flexible form device of claim 17, wherein the at least one connector delineating a fixed space between the first panel and the second panel.

20. The flexible form device of claim 13, wherein the at least one flexible panel being flexible along the length of the panel.
